(19) United States
(12) Patent Application Publication
(10) Pub. No.: US 2013/0173282 A1
(43) Pub. Date: Jul. 4, 2013

(54) Intelligent Cancer Prediction and Prevention System

(71) Applicant: Clarence Augustine Teck Huo Tee, Palo Alto, CA (US)

(72) Inventor: Clarence Augustine Teck Huo Tee, Palo Alto, CA (US)

(21) Appl. No.: 13/657,840

(22) Filed: Oct. 22, 2012

(30) Foreign Application Priority Data
Apr. 20, 2010 (MY) PI 2010001777
Feb. 17, 2011 (MY) PCT/MY2011/000013

(51) Int. Cl. G06F 19/00

(52) U.S. Cl. CPC G06F 19/3443
USPC 705/2

(57) ABSTRACT

The Intelligent Cancer Prediction and Prevention System (ICP²S) is a clinical decision support system built with our proprietary models and ideas based on data mining and knowledge discovery technology. The system contains a set of 33 novel data mining models stored in (e-Onco1) application database. The models use the classification approach algorithms of data mining technology to measure and predict the survivability of cancer patients based on the medical records of the patients. The models are designed to predict the percentage of survivability, five years after the time of diagnosis. The system contains novel user friendly interface that allows the oncologist to register the medical variables of the patients and generate the survivability reports. The system also contains a set of functionality that allows the system administrators to control and monitor the contents of the e-oncologist database.

### CROSS-REFERENCE TO RELATED APPLICATIONS

The present application claims priority to PCT/MY2011/000013 filed Feb. 17, 2011, which further claims priority to Malaysian Patent Application No. PI 2010001777 filed Apr. 20, 2010, the contents of all such applications being incorporated by reference herein in their entirety.

### FIELD OF THE INVENTION

This invention presents a novel idea of models and designs to help oncologist and medical professionals in eliminating the suffering and death due to cancer. The invention involves multiple scientific disciplines approach such as medicine, engineering, advanced data mining and data analysis algorithms and techniques based on clinical oncology and surgery databases.

### BACKGROUND OF THE INVENTION

Cancer is one of the most feared disease in the world. The rate of people getting cancer has increased dramatically recently. External factors such as environment, lifestyle, genetic, food intake and so on have played a significant role in deciding whether a person would be suffering from cancer or not.

As a result of the advancement of informatics and computer science, products like Clinical decision support systems (CDSS) becomes very useful in helping the oncology industry. CDSS is an interactive computer programs, which are designed to assist physicians and other health professionals with decision making tasks. The (CDSS) can be used to improve the process of diagnosis and treatments provided. But CDSS has it limitation also. Thus, the proposed approach here for our ICP²S.

### SUMMARY OF THE INVENTION

The present invention relates to a Decision Support System using data mining and knowledge discovery algorithms and techniques. The system is a tremendous help to oncologists and medical professionals. It is a decision support system to help oncologists in assessing the best treatment method for cancer patient based on existing cancer patients' databases and their treatment portfolios. The system also involved the use of the CRISP-DM methodology in designing and building the data mining models that predict the survivability of the cancer patient based on the medical records of the patient. The invention involves the usage of several different software engineering platforms, relational database management systems and data analysis and modeling tools.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a flowchart about the process of e-Oncologist upload data (e-OUD)”

FIG. 2 is a flowchart about the process of e-Oncologist data preparation (e-OPD)”

FIG. 3 is the Entity Relationship Diagram (ERD) for e-Oncologist.com web site

FIG. 4 is to describe the work of the web site template for e-Oncologist.com web site.

FIG. 5 is to describe the starchier of the “e-Onco Admin” Application.

FIG. 6 is to describe the starchier of the “e-Onco1” Application.

FIG. 7 is to describe the starchier of the “e-Onco1 model” data mining model.

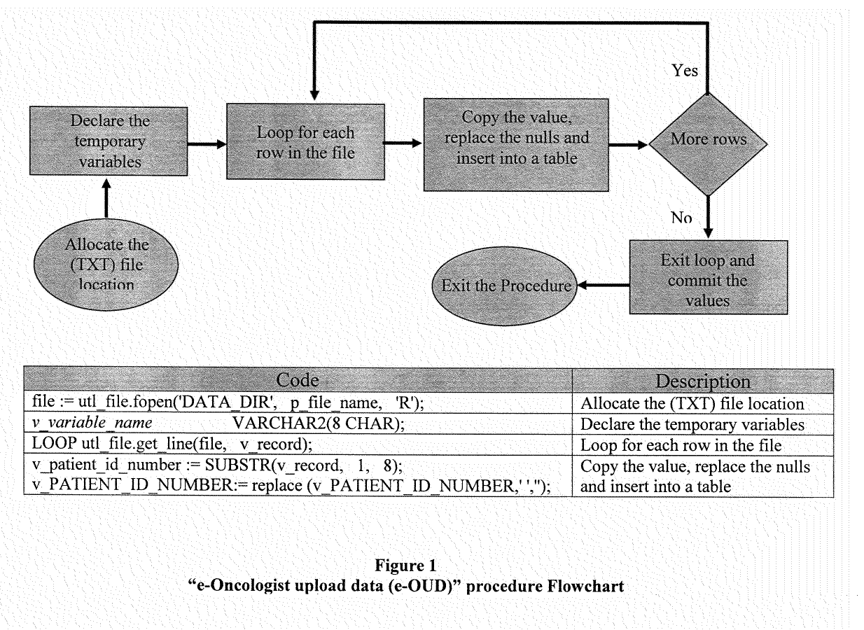

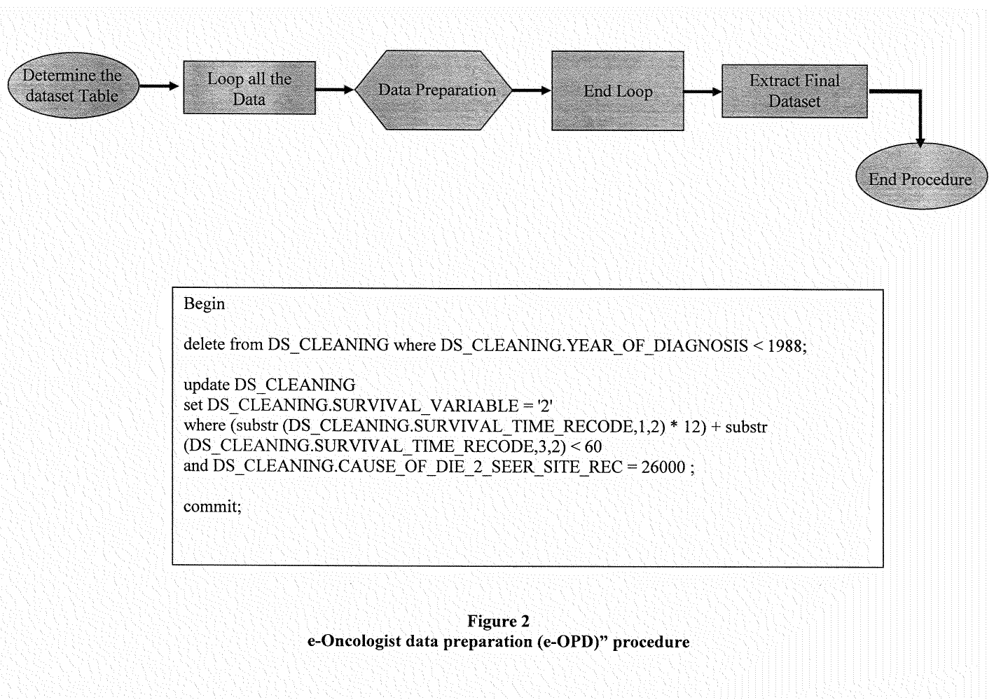

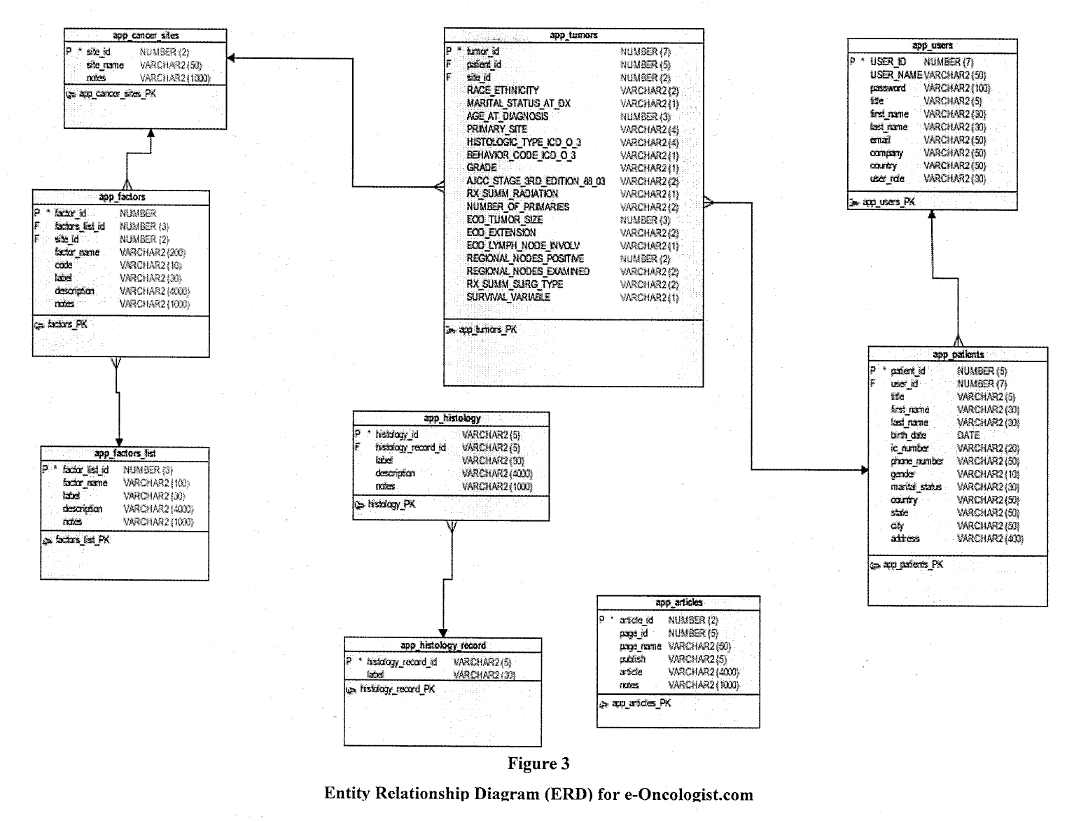

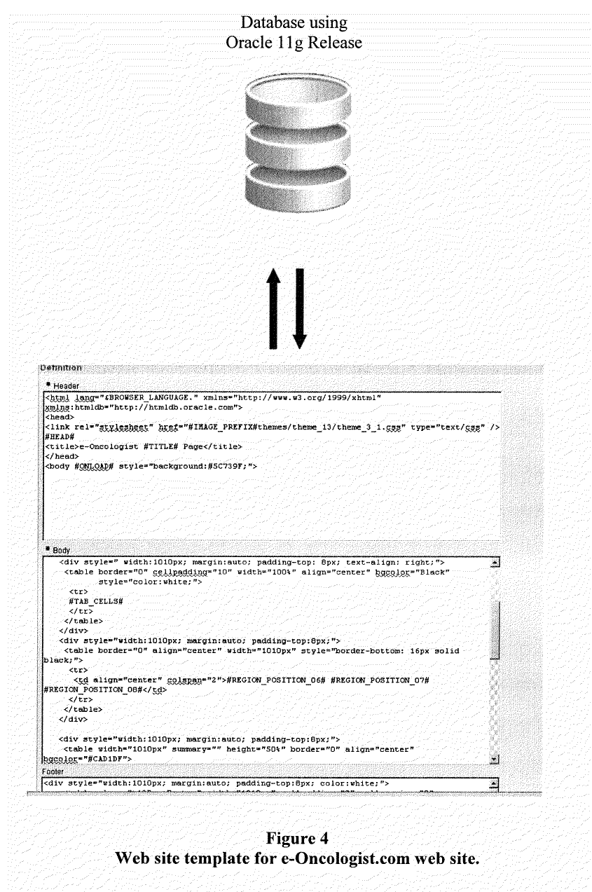

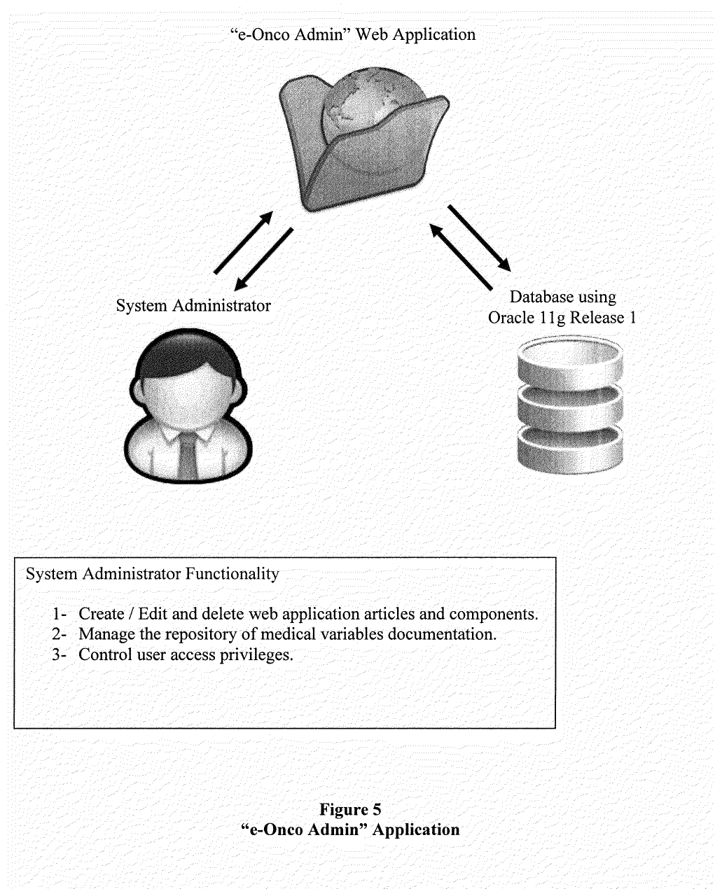

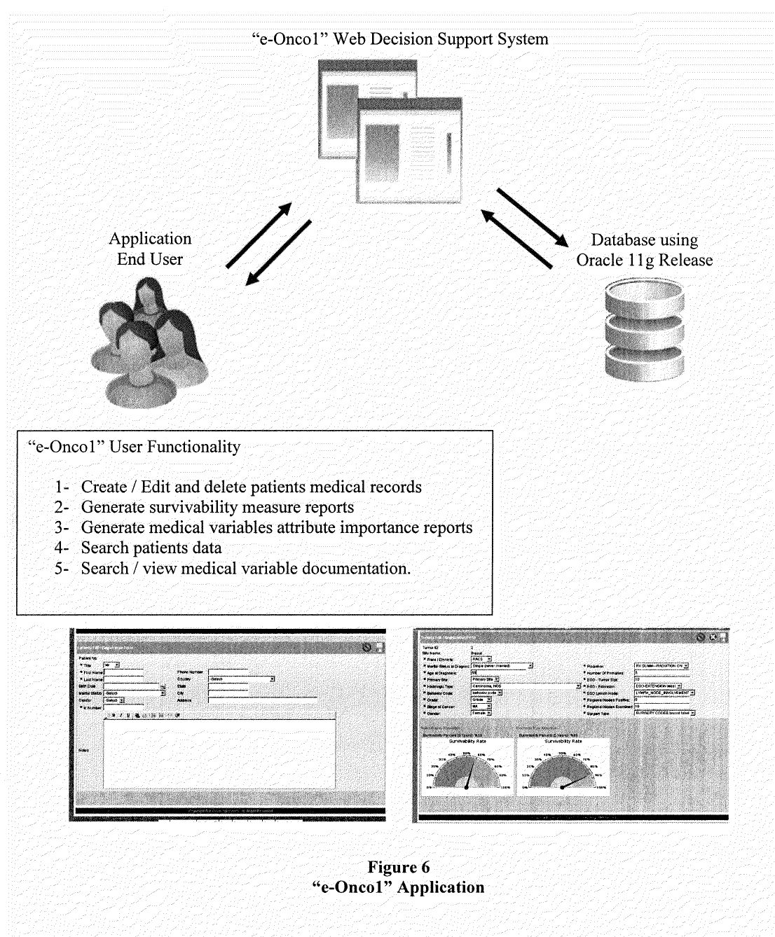

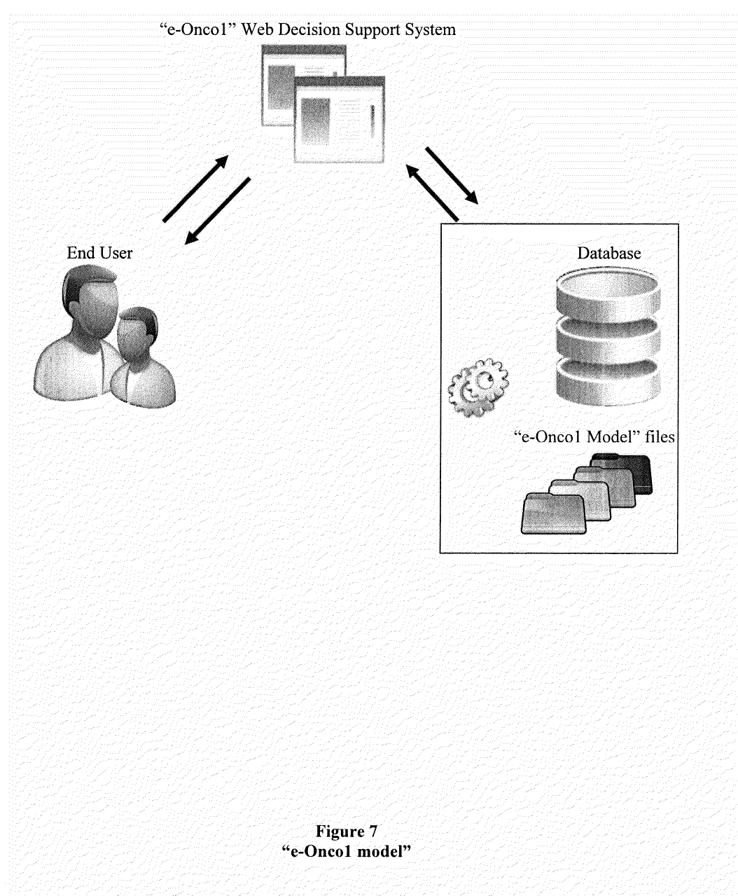

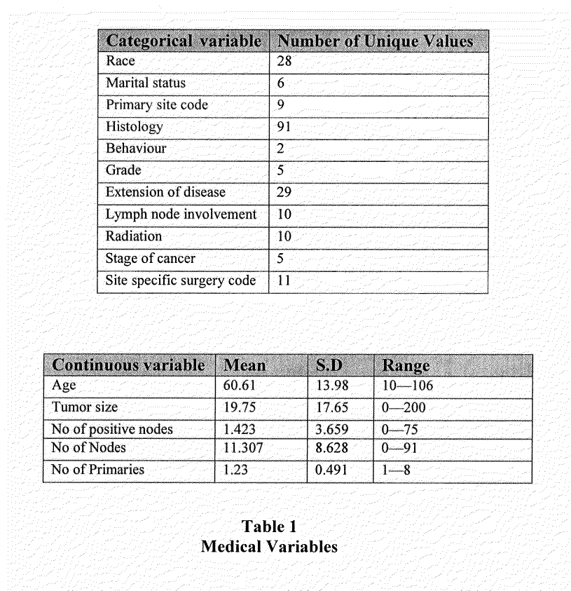

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Building a decision support system involves several work stages and techniques. The methodology of the invention contain the steps of obtaining the data from the data source, design and build the database, preparing the data sets for the mining activities, create the data mining model and build the clinical decision support system with the necessary friendly user interfaces and interactive reports. The next sections and paragraphs describe the details of each step in the methodology.

Data Source

In the present invention, the data set comes from SEER Cancer Incidence Public Use Database for the years 1973-2005. The Surveillance, Epidemiology, and End Results (SEER) Program of the National Cancer Institute (NCI) is an authoritative source of information on cancer incidence and survival in the United States (http://seer.cancer.gov).

The Surveillance, Epidemiology, and End Results (SEER) Program of the National Cancer Institute is responsible for the collection and reporting of cancer incidence and survival data from 15 population-based central cancer registries that cover 26 percent of the U.S. population. The U.S. racial/ethnic population coverage in SEER includes 23 percent of African Americans, 40 percent of Hispanics, 42 percent of American Indians and Alaska Natives, 53 percent of Asians, and 70 percent of Native Hawaiian and other Pacific Islanders.

The SEER public use data comes in a format of fixed width (TXT) files. Each data file contains the medical records of cancer patients for one or more cancer sites. The data files include patients' demographic information as well as primary tumor site, tumor morphology and stage at diagnosis, first course of cancer treatment, and follow-up for vital status. SEER began collecting data on cancers diagnosed on Jan. 1, 1973, which enables the analysis of longitudinal trends as well as current patterns of cancer. The SEER database is considered to be “most comprehensive source of information on cancer incidence and survival in the USA”.

Database and Data Mining Approach

The database model is the infrastructure of creating novel data mining models that gives the survivability rate of the cancer patients. Designing a relational database that fits the goals of creating the mining models is the very first stage of building the decision support system. The database will be used to create data mining models that predict the survivability of the patients for the following cancer sites: Lung; Pancreas; Prostate; Rectum; Stomach; Ovary; Cervix; Colon; Corpus and Esophagus.

The database will generate the final data sets that would be fed into the data mining modeling tools. Based on the related research papers and work like Dursun Delen, Predicting breast cancer survivability: a comparison of three data mining methods and Abdelghani Bellaachia, Erhan Guven. Predicting Breast Cancer Survivability and based on the required functions of the model we decided to use the classification approach of data mining. Classification is a data mining (machine learning) technique used to predict group membership for data instances. This approach involves several types of algorithms like decision tree and Naive Bayes.

Our proposed method will generate the final dataset that would be fed into the data mining modeling tools. Here is the summary of the design and process steps. Firstly, the data files need to be converted from the fixed width (TXT) file format and uploaded to several database tables. In order to design and build the relational database model and to identify the various relationships between the medical variables, we studied the SEER documentation files like [3-4] and also the other set of documents that were available in SEER web site. Secondly, we determine the unique numbers that identify each patient in SEER data files. The identification numbers are generated by the identifications such as the SEER ID Number, Registry ID and SEER Record Number (THE SEER PROGRAM CODING AND STAGING MANUAL). Thirdly, the set of the SEER documentation and appendixes are used to extract the legend and the descriptions for the values of the medical variables. For example, the legend and the demonstration of the values for the (EOD-Tumor Size) variable for each cancer site can be found in SEER EXTENT OF DISEASE—1988, CODES AND CODING INSTRUCTIONS THIRD EDITION. Finally, the database can be ready for data preparation and cleaning.

Data Understanding and Preparation

The pre-processing stage of the data (for the knowledge discovery using data mining approach) usually consumes the biggest portion of effort and time. Almost 80% of the time and effort in the innovation project was spent on cleaning and preparing the data for predictive modeling. Since the original SEER database records the data of the different cancer sites and patients, in the same database format, therefore the data files is the same. The documentation SEER Limited Use Record Description for Cases Diagnosed in 1973-2005 shows that there are about 115 different medical and non-medical variable recorded in SEER data sets files. Some of the variables are for documentation and staging purposes. Table 1 shows the medical variables that would be used to build our data mining models.

The cleaning process for the data files includes deletion, merging and mapping operations. A data analysis finds the variables that record the data on Extension of Disease (EOD) have missing values for the years prior to 1988. Since the (EOD) variables are important in the diagnosis and knowledge discovery process, the records that contain null values have been removed from the data sets files. For some other variables the records contain values to represent unknown data. The records that contain values like “9”, “99” and “999” have been excluded from the data sets files to make the results of the data mining more accurate with lower amount of data noise. The variables that record the site specific surgery code (SSS) have been separated to different columns after 1998. A mapping schema has been developed to transfer the data to the original (SSS) factor. SEER database uniquely identify patients records by numbers represent patient ID, registry ID and SEER record number. A new column called (CASE_ID) has been added to the dataset to contain the value of merging the three identification numbers. Another column (SURVIVAL_VARIABLE) column added to the data sets to contain a value that represent the survivability of each patient. This column contain the values (0, 1) to represent (did not survive and survive) respectively. The structure of the final data set files contain medical variables along with the unique identification and survival variables.

Data Mining and Knowledge Discovery

After preparing and generating the final data sets files for all the cancer sites the files was exported from the database to the data mining tool. The data mining algorithms for the classification approach have been used against the data sets to generate the survivability models. The classification approach algorithms (Decision tree and Naive Bayes) have used to generate the classification models. Each algorithm uses the medical variables along with unique identifier and survivability variables to find the patterns and the hidden information in each cancer site data set file.

Another approach of mining activities (Attribute Importance) used against the data set files to find the weight and the importance of each medical variable. The algorithm (Minimum Description Length) used to find what are the most important medical variables for each cancer sites. The result of Attribute Importance mining models will help the oncologist and researchers to understand the results of the survivability models.

The data mining tools will generate all the necessary codes that will be used by us to develop the decision support system. The decision support system software allows the oncologist, researchers and the medical experts to easily use the data mining models to measure the survivability of the patients. The software users can use the friendly user interface to register the medical variables of the patients and generate the results in the format of graphics and charts. The next section describes the details of technical tools that used in the invention.

Mining and Developing Tools

Several software development platforms, data manipulation and data mining tools have been used in the invention. The tools are used by us to design new models in creating the database, data preparation and processing and software development. Following are the tools that we used to create our models:

Oracle SQL Developer data modular version 2.0.0 (SQL Developer data modular description http://www.oracle.com/technology/products/database/datamodeler/index.html)

Oracle database 11 g enterprise edition with data mining and OLAP features (Oracle database description http://www.oracle.com/technology/products/database/oracle11g/index.html).

Oracle data miner (ODM) version 11.1 (Oracle ODM description http://www.oracle.com/technology/products/bi/odm/index.html).

Oracle SQL Developer version 1.2 (SQL Developer description http://www.oracle.com/technology/products/database/sql_developer/files/what_is_sqldev.html).

Oracle application express (APEX) version 3.2.1 (Oracle APEX description http://www.oracle.com/technology/products/database/application_express/index.html)

### INDUSTRIAL APPLICABILITY

The clinical decision support system will provide the oncologist with the ability to predict or measure the survivability of cancer patients 5 years after the data of diagnosis. The results of the model can help the oncologist design a treatment plan for the cancer patient according to his or her medical variables such as the stage of cancer and tumor size.

The following are aspects of the present invention.

“e-Oncologist upload data (e-OUD)” procedure:

The procedure developed using Procedural Language/Structured Query Language (PL/SQL). The function of the procedure is to upload (TXT) format data to Oracle database table. The procedure locate the path of the (TXT) file on the computer machine based of the Oracle directory object (directory synonym) provided by the database administrator (DBA). When the procedure runs it start to read the characters of the (TXT) file row by row. For each row it copies the characters to temporary declared variables. After that the values of the variables are placed in a (SQL) command that insert the data in certain database tables and column.

“e-Oncologist Clean Data (e-OCD)” Procedure:

The procedure is developed using Procedural Language/Structured Query Language (PL/SQL). The function of the procedure is to do all the data preparation required for data mining models like (remove unknown values, remove out of rang values, mapping values between cretin database tables and columns). When the procedure runs it starts loop all the records in the dataset table to do the defined necessary preparation and generate the final dataset for the data mining.

Entity Relationship Diagram (ERD) for e-Oncologist.com

The backend diagram of the e-oncologist.com web site consist of several tables to save user data, the medical records and the data mining models data. The diagram allows the tool to generate different types of medical and statistical reports. The diagram contains all the entities and the database objects that allow the implementation of web application features. E-oncologist.com has the features of control the access to the application pages and administration pages by authentication schema a virtual private database for each user.

Web Site Template for e-Oncologist.com Web Site.

The web site template has been developed using HyperText Markup Language (HTML), Cascading Style Sheet (CSS) and java script. The template allows the developers to easily develop and embed Oracle database form and report using Oracle Application Express platform (APEX). The template uses (HTML) text editor that allows the web site masters to easily create and edit the contents of the web site. The (HTML) text editor converts all the articles written by the web masters to (HTML) format and inserts it on Oracle database tables. The web site contains also graphic design developed by e-Oncologist.com graphic designer.

“e-Onco Admin” Application

An administration application allows the web site masters for e-oncologist.com to do all the web site administration functionality. The (e-Onco Admin) allows the web masters to easily create and edit the web site components including web pages articles, user privileges, medical documentation and much more.

“e-Onco1” Application

An application allows the oncologists, medical experts and the researchers to measure the survivability of the cancer patients. The application built with all the necessary tools and interfaces to register and save the medical record of the patients. The users can use the medical data of the patients to generate a real time report about the survivability of the patients. Users can also use e-Onco1 to find information about all the medical variables for cancer patients like (Stage of Cancer, Tumor Size etc.) in very organized and easy access interface. An Attribute Importance (AI) page is also available to provide reports in a text and chart formats about the importance and the weight for each individual medical variable in the data mining models.

“e-Onco1 Model”

e-Onco1 Model is built by combining 33 different data mining models. The models built using the classification approach algorithms like (Decision Tree) and (Naive Bayes). Another type of algorithms (Minimum Description Length) used to build medical variables importance in the mining process. E-Onco1 Model can measure the survivability 11 different site of cancer. The list of cancer sites that e-Onco1 can works on is

| | |
|---|---|
| Breast | Pancreas |
| Colon | Prostate |
| Cervix | Rectum |
| Corpus | Stomach |
| Esophagus | Ovary |
| Lung | |

Oncologist and researchers can use e-Onco1 model by registering on www.e-oncology.com and use the (e-Onco1) application.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A Decision Support System, comprising:
data mining and knowledge discovery algorithms and techniques for assessing the best treatment method for cancer patient based on existing cancer patients' databases and their treatment portfolios;
a CRISP-DM methodology for designing and building the data mining models that predict the survivability of the cancer patient based on the medical records of the patient; and
software engineering platforms, relational database management systems and data analysis and modeling tools.
